(19) United States
(12) Patent Application Publication
(10) Pub. No.: US 2018/0137975 A1
(43) Pub. Date: May 17, 2018

(54) THIN FILM-TYPE INDUCTOR AND METHOD FOR MANUFACTURING THE SAME

(71) Applicant: SAMSUNG ELECTRO-MECHANICS CO., LTD., Suwon-Si (KR)

(72) Inventors: Il Ho CHA, Suwon-Si (KR); Sang Jae LEE, Suwon-Si (KR); Ho Sik PARK, Suwon-Si (KR); Hye Hun PARK, Suwon-Si (KR); Kwang Jik LEE, Suwon-Si (KR); Hye Yeon CHA, Suwon-Si (KR); Jae Ha KIM, Suwon-Si (KR)

(21) Appl. No.: 15/674,202

(22) Filed: Aug. 10, 2017

(30) Foreign Application Priority Data
Nov. 15, 2016 (KR) 10-2016-0151994

(51) Int. Cl. H01F 41/04; H01F 41/12; H01F 17/00; H01F 41/10

(52) U.S. Cl. CPC H01F 41/042; H01F 41/125; H01F 10/00; H01F 41/10; H01F 17/0006

(57) ABSTRACT

A thin film-type inductor includes a body including a support member, a coil disposed. on at least one surface of the support member, and a filler embedding the support member on which the coil is disposed, and an external electrode disposed. on an external surface of the body. An insulating layer is not disposed on an edge portion of the support member and the edge portion is in direct contact with a filler. The insulating layer is only disposed on an upper surface of the coil to conform to a surface of the coil.

### CROSS-REFERENCE TO RELATED APPLICATION(S)

This application claims the benefit of priority to Korean Patent Application No. 10-2016-0151994, filed on Nov. 15, 2016 in the Korean Intellectual Property Office, the disclosure of which is incorporated herein by reference in its entirety.

### BACKGROUND

### 1. Field

The present disclosure relates to a thin film-type inductor and a method for manufacturing the same, and more particularly, to a thin film power inductor and a method for manufacturing the same.

### 2. Description of Related Art

Recently, diversification of functions of mobile devices has led to an increase in power consumption thereof, and thus, passive components which have minimal loss and have excellent efficiency are employed in the vicinity of power management integrated circuits (PMICs) to increase a battery usage time of mobile devices. Among the passive elements, a compact, low-profile power inductor with excellent efficiency, allowing for a reduction in a product size and increasing battery capacity, tends to be preferred.

A thin film-type inductor may be manufactured through a basic process of forming a coil conductive pattern part through plating and subsequently stacking, compressing, and curing of magnetic sheets formed by mixing a magnetic powder and a resin. Here, in order to prevent the coil conductive pattern part and the magnetic material from coming into contact with each other, an insulating layer is formed on a surface of the coil conductive pattern part.

In Japanese Patent Laid-open Publication No. 2005-210010, after a coil conductor is formed, a protective resin layer is applied to the coil conductor to insulate the coil conductor. In this document, however, when an aspect ratio of the coil conductor is increased, a lower region of the coil conductor may not be insulated, frequently causing a void.

### SUMMARY

An aspect of the present disclosure may provide a thin film-type inductor in which a thickness of an insulating layer is uniform throughout the entire region of a coil surface such that a void is not formed.

According to an aspect of the present disclosure, a thin film-type inductor may include a body and an external electrode disposed on an external surface of the body. The body may include a support member, a coil including a plurality of conductive patterns supported by the support member, and a filler embedding the coil and the support member. The support member may include at least two edge portions as parts not supporting the coil. The edge portions may be in direct contact with the filer without an insulating layer intervening, and the insulating layer may be disposed on a surface of the coil to conform to a shape of a surface of the coil. Also, the filler may fill a space between conductive patterns adjacent to each other, together with the insulating layer disposed on the surfaces of the conductive patterns.

According to another aspect of the present disclosure, a method for manufacturing a thin film-type inductor may include: forming a plurality of conductive patterns on at least one surface of a support member to dispose a coil; disposing an insulating layer on a surface of the coil to conform to a shape of the surface of the coil; disposing a filler with magnetic properties on upper and lower surfaces of the support member to form a body embedding both the support member and the coil; and forming an external electrode connected to the coil on an external surface of the body. The insulating layer may not be disposed on a surface of an edge portion of the support member, and the surface of the edge portion of the support member may be in direct contact with the filler.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view of a thin film-type inductor according to an exemplary embodiment in the present disclosure;

FIG. 2 is a schematic cross-sectional view taken along line I-I′ of FIG. 1;

FIG. 3 is an enlarged view of a portion “A” of FIG. 2;

FIG. 4 is a schematic cross-sectional view of a thin film-type inductor according to another exemplary embodiment;

FIG. 5 is an enlarged view of a portion “A′” of FIG. 4; and

FIGS. 6A through 6D are drawings schematically illustrating a process of manufacturing a thin film-type inductor according to another exemplary embodiment in the present d disclosure.

### DETAILED DESCRIPTION

Exemplary embodiments in the present disclosure will now be described in detail with reference to the accompanying drawings.

Hereinafter, a thin film-type inductor and a manufacturing method thereof according to an exemplary embodiment in the present disclosure will be described but the present disclosure is not limited thereto.

### Thin Film-Type Inductor

In a related art thin film-type inductor, in order to dispose an insulating layer to prevent contact between a coil and a magnetic material, a chemical vapor deposition (CVD) method is widely used. Here, the insulating layer of the related art thin film-type inductor extends to regions not requiring insulations, such as a surface of a substrate excluding a coil surface. In addition, an excessive insulation time (about 20 hours or longer) is required to form the insulating layer.

According to an exemplary embodiment in the present disclosure, a thin film-type inductor does not include the insulating layer formed in regions not requiring insulation. Hence, more space may be filled with a magnetic material rather than the insulating layer, which enhances the magnetic permeability of the thin film-type inductor. This will be described in detail hereinafter.

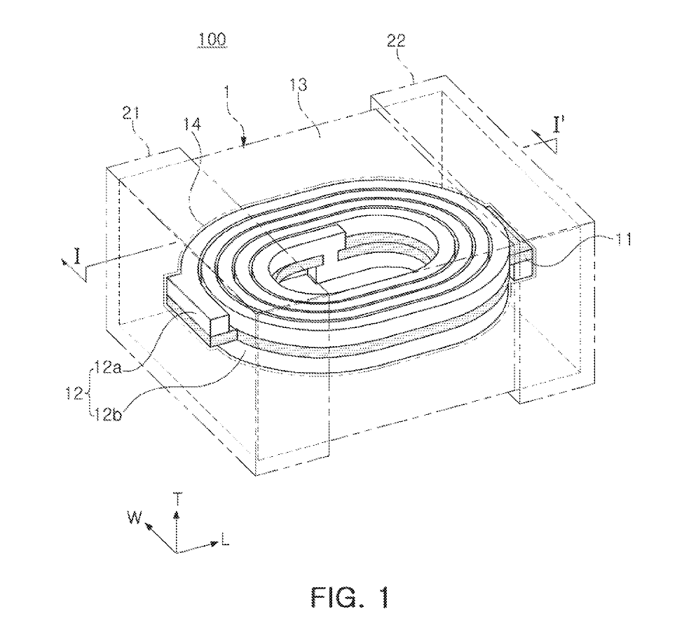

FIG. 1 is a schematic perspective view of a thin film-type inductor according to an exemplary embodiment in the present disclosure.

Referring to FIG. 1, a thin film-type inductor 100 according to an exemplary embodiment includes a body 1 and first and second external electrodes 21 and 22 disposed on an external surface of the body 1. The body 1 includes a support member 11, a coil 12 including an upper coil 12a disposed on an upper surface of the support member 11 and a lower coil 12b disposed on a lower surface of the support member 11, and a filler 13 embedding the support member 11 and the coil 12.

The support member 11 serves to allow the coil 12 to be easily formed to be thin. The support member 11 may be an insulating substrate formed of an insulating resin, and here, as the insulating resin, a thermosetting resin such as an epoxy resin, a thermoplastic resin such as polyimide, or a resin obtained by impregnating the thermosetting resin or the thermoplastic resin with a stiffener such as glass fiber or an inorganic filler, for example, prepreg, an Ajinomoto Build-up Film (ABF), FR-4, a bismaleimide triazine (PT) resin, a photo imageable dielectric (PID) resin, and the like, may be used. Inclusion of glass fiber in the support member 11 ensures better rigidity. A through hole may be provided in a central portion of the support member 11 and filled with a filler to form a central core part.

The support member 11 may have a thin plate shape with a predetermined thickness and may include at least two edge portions. A coil is not provided on the edge portions.

The coil 12 includes a metal with excellent electrical conductivity. For example, the coil may be formed of silver (Ag), palladium (Pd), aluminum (Al), nickel (Ni), titanium (Ti) gold (Au), copper (Cu), platinum (Pt), or an alloy thereof.

The coil 12 may have a spiral shape overall. A plurality of conductive patterns 121, 122, 123, . . . are continuously provided to form a single coil.

A height of the coil 12 is not limited, but in order to improve electrical properties by lowering direct current (DC) resistance (Rdc) of the inductor 100, an aspect ratio (AR) is preferably increased. For example, an average height of a conductive pattern may be within a range from 100 μm to 300 μm.

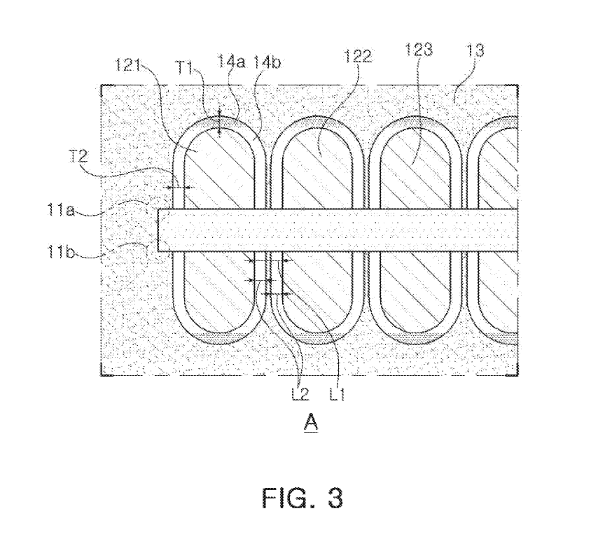

An insulating layer 14 is disposed on a surface of the coil 12. The insulating layer 14 is disposed to conform to a shape of an outer surface of the coil 12 to prevent contact between the coil 12 and the filler 13. To this end, the insulating layer 14 includes a material with insulating properties. In particular, the insulating layer 14 includes a material allowing for electrodeposition coating, among materials with insulating properties, as described hereinafter with reference to FIG. 3.

The filler 13 embedding both the support member 11 and the coil 12 forms an appearance of the thin film-type inductor 100 and includes a material exhibiting magnetic properties. As a material exhibiting magnetic properties, for example, ferrite or a metal-based soft magnetic material may be used. The ferrite may include Mn—Zn-based ferrite, Ni—Zn-based ferrite, Ni—Zn—Cu-based ferrite, Mn—Mg-based ferrite, Ba-based ferrite, Li-based ferrite, and the like. The metal-based soft magnetic material may be an alloy including one or more selected from the group consisting of iron (Fe), silicon (Si), chromium (Cr), aluminum (Al) and nickel (Ni) and include Fe—Si—B—Cr-based amorphous metal particle, for example. The metal-based soft magnetic material may be included such that it is dispersed in a polymer such as polyimide or an epoxy resin.

The filler 13 includes the same material as that of the support member 11 to significantly enhance bonding force with an edge portion of the support member 11 in direct contact with the filler 13. Referring to the related art inductor, since the insulating layer extends to be formed even in a portion not requiring insulating properties, such as an edge portion of the support member, or the like, even when the insulating layer with bonding force with respect to the filler with magnetic properties is provided, the filler and the insulating layer are bonded, forming a structurally unstable structure. However, in the thin film-type inductor 100 according to an exemplary embodiment, since the edge portion of the support member 11 is in direct contact with the filler, when the filler 13 and the support member 11 are formed of materials having similar physical properties, bonding force may be significantly improved.

As illustrated in FIG. 1, the first and second external electrodes 21 and 22 may have a C shape. However, a shape of the first and second external electrodes 21 and 22 is not limited thereto and the first and second external electrodes 21 and 22 may have any other shapes, for example, an L shape or an I shape. Since the first and second external electrodes 21 and 22 are connected to a lead portion of the coil 11 to exhibit electrical properties, the first and second external electrodes 21 and 22 may include a metal with excellent electrical conductivity. For example, the first and second external electrodes 21 and 22 maybe formed of silver (Ag), palladium (Pd), aluminum (Al), nickel (Ni), titanium (Ti), gold (Au), copper (Cu), platinum (Pt), or an alloy thereof. Also, the first and second external electrodes 21 and 22 maybe configured as a plurality of layers or may include a copper (Cu) line plating layer facilitating plating inwardly.

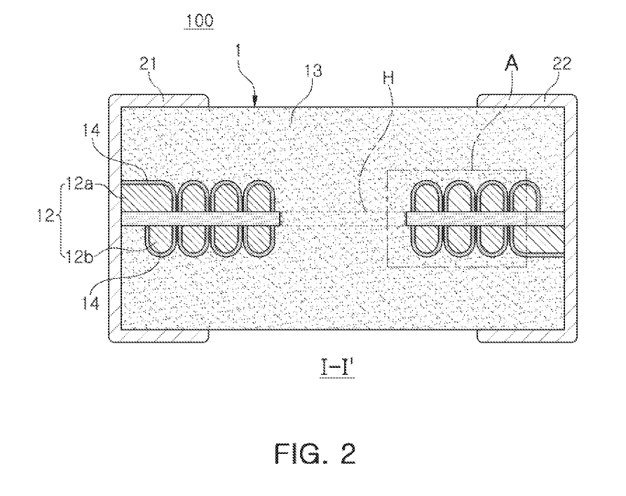

FIG. 2 is a schematic cross-sectional view taken along line I-I′ of FIG. 1 and FIG. 3 is an enlarged view of a portion “A” of FIG. 2.

Referring to FIGS. 2 and 3, the insulating layer 14 is disposed on the coil 12 of the thin film-type inductor 100, and here, the insulating layer 14 is formed to conform to a shape of a surface of the coil 11.

Here, forming the insulating layer 14 to conform to a shape of the surface of the coil 11 means that the insulating layer is directly formed on the surface of the coil and an insulating layer 14a disposed on an upper surface of the coil 11 and an insulating layer 14b disposed on a side surface of the coil 11 are continuously formed.

Also, a ratio (T1/T2) of a thickness T1 of the insulating layer 14a. disposed. on the upper surface of the coil 11 to a thickness T2 of the insulating layer 14b disposed on the side surface of the coil 11 is within a range of 0.95 to 1.0. If the ratio is greater than 1.0, the insulating layer on the upper surface of the coil 11 may be greater than the insulating layer on the side surface of the coil 11, and here, it is difficult to control the insulating layer on the upper surface of the coil 11 to be thicker in terms of characteristics of the electrodeposition coating. If the ratio is smaller than 0.95, a thickness deviation of the insulating layer on the upper. surface of the coil 11 and the thickness of the insulating layer on the side surface of the coil 11 may exceed 5%, degrading uniformity of the thickness of the insulating layer 14. Thus, the insulating layer 14 of the thin film-type inductor 100 of the present disclosure is advantageous for maintaining uniformity of the thickness. In general, the insulating layer develops to be thick over time. However, since the insulating layer is formed through electrodeposition coating, the insulating layer 14 is not thickened over time unless an applied current is increased.

Also, it is possible for the insulating layer 14 to be delaminated from the coil 11. Thus, after the insulating layer 14 is selectively delaminated, the insulating layer 14 may coat the coil 11 again through reworking.

The insulating layer 14 is not disposed on a region other than the surface of the coil. In detail, the insulating layer 14 is not disposed on edge portions 11a and 11b of the support member 11. Thus, since the insulating layer 14 is not formed on portions not requiring insulation, such as the edge portions 11a and 11b of the support member 11, or the like, a relatively greater amount of filler 13 with magnetic properties may be provided to improve inductance of the inductor 100. In particular, the insulating layer 14 is not disposed on edges of a through hole H formed at a central portion of the support member 11 and the filler 13 is in direct contact with the inside of the through hole and the vicinity thereof. Securing the through hole H significantly improves a volume of the filler 13 to increase inductance.

Referring to FIGS. 2 and 3, a space between two adjacent conductive patterns 121 and 122, each including the side insulating layer 14b on a side surface thereof, among a plurality of conductive patterns, is filled with the filler 13. This is because the insulating layer 14 disposed on the conductive patterns does not extend to a region other than the surfaces of the conductive patterns, and also, the insulating layer 14 is relatively thin. In detail, a distance L1 between the conductive pattern 121 and another conductive pattern 122 adjacent thereto on the surface of the support member 11 is greater than a sum of thicknesses L2 of the insulating layer 14b on the side surfaces of each of the conductive patterns 121 and 122, and thus, a portion of the surface of the support member 11 is in direct contact with the filler 13 at the distance L1. That is, a disconnection part of the insulating layer is formed between the insulating layer 14b of the conductive pattern 121 and the insulating layer 14b of the conductive pattern 122, and the filler 13 fills a space of the disconnection part.

The insulating layer 14 is preferably formed of an epoxy-based resin allowing for application of the electrodeposition coating, among insulating materials. For example, the insulating layer 14 may include one or more of an epoxy-based resin, an acrylic resin, and a urethane-based resin. Also, the insulating layer 14 may further include an additive in addition to the principal resin, and here, the additive may serve as a reinforcing agent for further enhancing specific characteristics of the insulating layer 14. For example, polyimide may be further added to improve thermal decomposition characteristics and an appropriate additive may be selected by a person skilled in the art to improve characteristics.

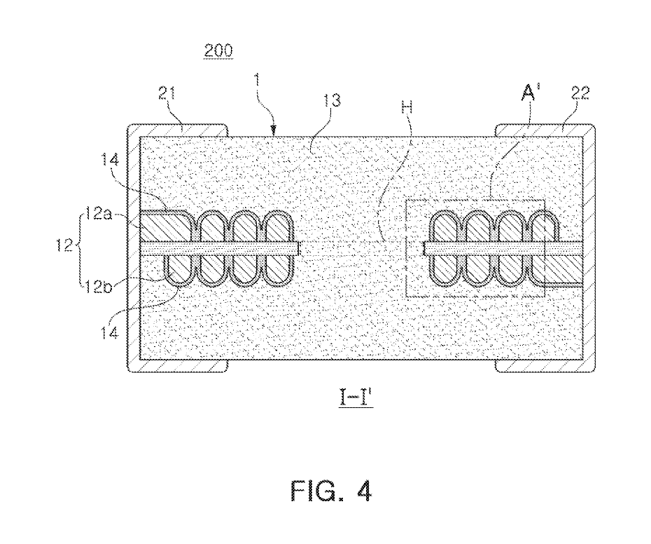

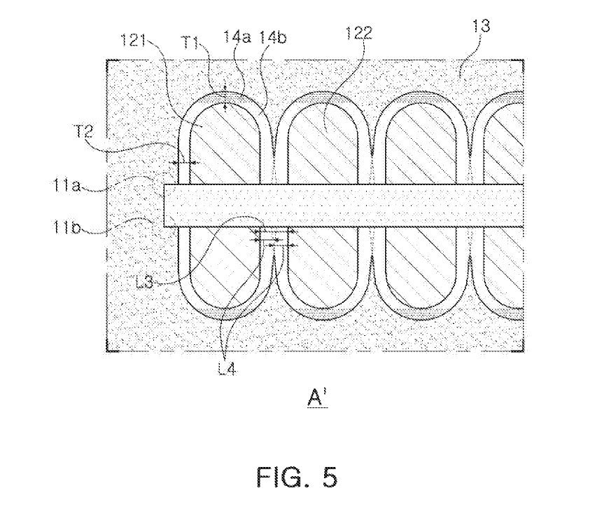

FIG. 4 is a schematic cross-sectional view of a thin film-type inductor according to another exemplary embodiment and FIG. 5 is an enlarged view of a portion “A′ ” of FIG. 4. FIGS. 4 and 5 are different from FIGS. 2 and 3 in that a space between conductive patterns is relatively narrow, and thus, the same descriptions as those of FIGS. 2 and 3 will be omitted. Also, for the purposes of description, components corresponding to FIGS. 2 and 3 will be given the same reference numerals.

Referring to FIGS. 4 and 5, in a thin film-type inductor 200, a distance between two adjacent conductive patterns 121 and 122, among a plurality of conductive patterns, is small. This may be advantageous in that the number of turns of a coil may be increased within the same space and an overall size of the inductor may be increased when the same number of turns of a coil is included.

Similarly, in FIGS. 4 and 5, in the thin film-type inductor 200 of the present disclosure, an insulating layer does not extend to the edge portions 11a and 11b of the support member 11, and thus, the support member 11 and the filler 13 are in direct contact with each other and the insulating layer 14 is formed to conform to a shape of the surface of the coil 12.

However, in the thin film-type inductor 200, since a distance L3 between two adjacent conductive patterns 121 and 122 is small, the distance L3 on a surface of the support member 12 is equal to or smaller than a sum of the thicknesses of the insulating layers 14b on the side surfaces of each of the conductive patterns 121 and 122. As a result, the surface of the support member 12 is not in direct contact with the filler in a region of the distance L3 but it is common that a space between the conductive patterns 121 and 122 in the region of the distance L3 is filled with the filler 13.

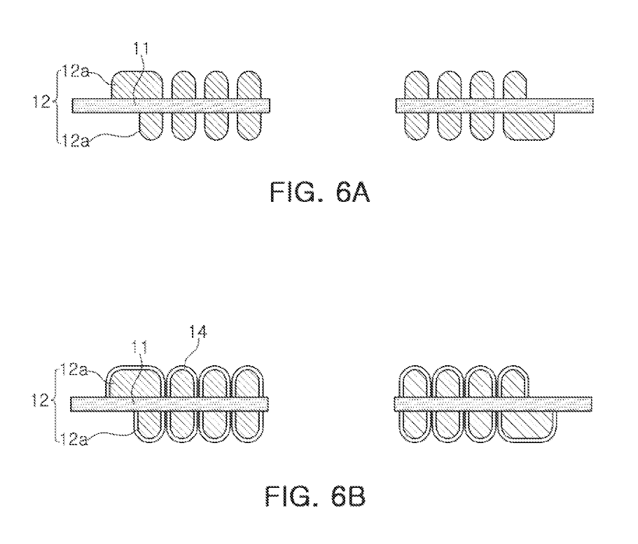

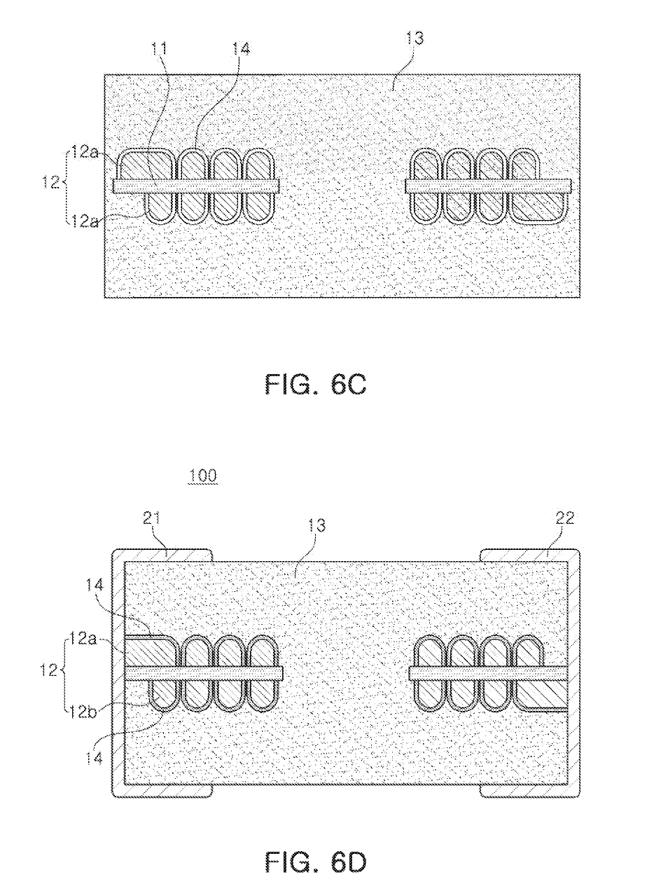

Hereinafter, a method for manufacturing a thin film-type inductor of the present disclosure will be described with reference to FIG. 6.

### Method for Manufacturing Thin Film-Type Inductor

Referring to FIG. 6A, first, a plurality of conductive patterns are formed on at least one surface of a support member to manufacture a coil. The conductive patterns may be formed through an electroplating method, but without being limited thereto. A through hole is preferably formed at a central portion of the support member through drilling, laser, sand blasting, punching, and the like. Also, a via hole is formed in a portion of the support member and filled with a conductive material to form a via electrode (not shown) to electrically connect the coil formed on opposing surfaces of the support member.

Referring to FIG. 6B, an insulating layer configured to conform to a shape of a surface of the coil is disposed on upper surfaces of the conductive patterns. The insulating layer is formed through electrodeposition coating which serves to enable the insulating layer to be formed only on the surfaces of the conductive patterns including a metal. A specific method of the electrodeposition coating is not limited only to an embodiment, and, for example, the insulating layer may be formed through cation electrodeposition coating. The insulating layer is preferably formed to be thinner than the conductive patterns therebelow, and a thickness of the insulating layer may be controlled by setting an electrodeposition voltage. In the electrodeposition coating, thickness growth of the insulating layer is stopped in a stage in which the insulating layer having a thickness in accordance with an applied voltage is formed on the surfaces of the conductive patterns. Also, a resin allowing for application of electrodeposition coating, such as an epoxy-based resin, an acrylic resin, a urethane-based resin, and the like, may be used, and in order to improve characteristics, a predetermined additive may be added. For example, in order to improve adhesiveness with a plated pattern, strengthen a bonding force with a filler, improve heat-resistance characteristics, prevent generation of an oxide film, and the like, a person skilled in the art may add a predetermined additive as necessary. Also, after formation of the insulating layer, the insulating layer may be cured by applying a UV method or a heating method. In particular, the use of the TV method may effectively prevent the insulating layer generated by electro-depositing resin pigment from being pushed downwards along a side surface from an upper surface.

Referring to FIG. 6C, a filler having magnetic properties may be provided to upper and lower sides of the support member on which the coil is formed. A filling method is not limited but the filler may be provided through a laminating method of stacking magnetic sheets or compressing through an isostatic pressing method. Here, when a through hole is formed in the central portion of the support member, the inside of the through hole is filled with the filler and the filler may be in direct contact with edges of the through hole and the vicinity thereof. Also, the filler is disposed between adjacent conductive patterns, and this is because an extra space allowing the filler to penetrate thereto may be secured as the thin insulating layer is only disposed on a surface of the coil.

Referring to FIG. 6D, predetermined dicing is applied to the appearance of the body including the filler to form an external electrode connected to an exposed lead portion of the coil. A method for forming the external electrode is not limited, and for example, a plating method or a dipping method may be used.

Redundant descriptions of the characteristics of the thin film-type inductor according to the exemplary embodiments described above will be omitted.

One of the technical problems to be solved by the present disclosure is to dispose the insulating layer with a uniform thickness, without causing a void in the entire region of the coil surface.

As set forth above, according to exemplary embodiments in the present disclosure, the insulating layer is not disposed in a region where the insulating layer is unnecessary and is reliably disposed in a region where the insulating layer is required to be disposed without causing a void, thus improving the magnetic permeability and reliability of the inductor.

While exemplary embodiments have been shown and described above, it will be apparent to those skilled in the art that modifications and variations could be made without departing from the scope of the present invention as defined by the appended claims.

What is claimed is:

1. A thin film-type inductor comprising:
a body including a support member, a coil including a plurality of conductive patterns disposed on at least one surface of the support member and an insulating layer formed on surfaces of the plurality of conductive patterns to conform to a shape of the surfaces of the plurality of conductive patterns, and a filler having magnetic properties and embedding the coil and the support member; and
an external electrode electrically connected to the coil and disposed on an external surface of the body,
wherein the support member includes at least two edge portions, the edge portions are in direct contact with the filler, and the filler fills a space between conductive patterns adjacent to each other.

2. The thin film-type inductor of claim 1, wherein the insulating layer includes one or more of an epoxy-based resin, an acrylic resin, and a urethane-based resin.

3. The thin film-type inductor of claim 2, wherein the insulating layer further includes polyimide.

4. The thin film-type inductor of claim 1, wherein a central portion of the support member includes a through hole, and an edge of the through hole is in direct contact with the filler.

5. The thin film-type inductor of claim 1, wherein a thickness of an insulating layer disposed on an upper surface of each of the plurality of conductive patterns of the coil is equal to or smaller than a thickness of an insulating layer disposed on a side surface of each of the plurality of conductive patterns of the coil

6. The thin film-type inductor of claim 1, wherein an average height of the plurality of conductive patterns is within a range from 100 μm to 300 μm.

7. The thin film-type inductor of claim 1, wherein the plurality of conductive patterns include a first conductive pattern and a second conductive pattern, a disconnection part is disposed on a surface of the support member in a space between a first insulating layer disposed on a side surface of the first conductive pattern and a second insulating layer disposed on a side surface of the second conductive pattern and facing the first insulating layer to separate the first and second insulating layer, and the filler is disposed within the disconnection part.

8. The thin film-type inductor of claim 1, wherein the support member includes the same material as that of the filler.

9. The thin film-type inductor of claim 5, wherein a ratio of the thickness of the insulating layer disposed on the upper surface of each of the plurality of conductive patterns of the coil to the thickness of the insulating layer disposed on the side surface of each of the plurality of conductive patterns of the coil is within a range of 0.95 to 1.0.

10. A method for manufacturing a thin film-type inductor, the method comprising steps of:
forming a plurality of conductive patterns on at least one surface of a support member to form a coil;
disposing an insulating layer on a surface of the coil to conform to a shape of the surface of the coil;
disposing a filler with magnetic properties on upper and lower surfaces of the support member to form a body embedding both the support member and the coil; and
forming an external electrode connected to the coil on an external surface of the body,
wherein the insulating layer is not disposed on a surface of an edge portion of the support member, and the surface of the edge portion of the support member is in direct contact with the filler.

11. The method of claim 10, wherein the step of disposing the insulating layer uses electrodeposition coating.

12. The method of claim 11, wherein the step of disposing the insulating layer using electrodeposition coating further comprises fixating the insulating layer using a UV method.

13. The method of claim 11, wherein the electrodeposition coating is a cation electrodeposition coating.

14. The method of claim 10, wherein the insulating layer includes an acrylic resin or a urethane-based resin.

15. The method of claim 14, wherein the insulating layer further includes a polyimide resin.

16. The method of claim 10, wherein a space between the conductive patterns adjacent to each other is filled with a filler.

17. The method of claim 10, further comprising a step of forming a through hole in a central portion of the support member on which the coil is disposed, and allowing the filler to be in contact with edges of the through hole and the vicinity thereof.
